(19) United States
(12) Patent Application Publication
(10) Pub. No.: US 2026/0045775 A1
(43) Pub. Date: Feb. 12, 2026

(54) PROTECTOR AND WIRE HARNESS

(71) Applicant: SUMITOMO WIRING SYSTEMS, LTD., Yokkaichi-shi, Mie (JP)

(72) Inventor: Kazuma OGINO, Yokkaichi-shi (JP)

(73) Assignee: SUMITOMO WIRING SYSTEMS, LTD., Yokkaichi-shi, Mie (JP)

(21) Appl. No.: 19/099,695

(22) PCT Filed: Jul. 18, 2023
(86) PCT No.: PCT/JP2023/026286

§ 371 Date: Jan. 29, 2025

(30) Foreign Application Priority Data
Aug. 5, 2022 (JP) 2022-125569

(51) Int. Cl. H02G 3/04; B60R 16/02; H01B 7/00

(52) U.S. Cl. CPC H02G 3/0437; B60R 16/0215; H01B 7/0045; H02G 3/0418

(57) ABSTRACT

A protector that is configured to be fixed to an attachment target, integrally with a wire, the protector including: a housing that is configured to accommodate the wire and includes an opening into which the wire is fit, wherein: the housing includes: (i) a support wall that is configured to support the wire that is accommodated in the housing, and (ii) a retaining section that is elastically deformable so as to retain the wire; the protector further includes a leg that is a plate protrusion protruding from the housing and extending in a longitudinal direction of the housing; and the support wall and the retaining section are configured to sandwich the wire therebetween so as to retain the wire.

### BACKGROUND

This disclosure relates to a protector and a wire harness.

Conventionally, as disclosed in Japanese Patent Application Publication No. 2021-57951, a clamp for attaching a tubular member having a wire therein to a vehicle or the like, and a wire harness including the same, are well known. The clamp includes a clamp main body having an opening into which the tubular member is fit, and a lid that is attached so as to cover the opening with respect to the clamp main body. Furthermore, a plate spring is formed at a bottom of the clamp main body at a portion of the bottom that contacts the tubular member.

### SUMMARY

The clamp disclosed in Japanese Patent Application Publication No. 2021-57951 has a two-part structure including a clamp main body and a lid, and is configured to retain the tubular member by sandwiching it between the plate spring of the clamp main body and the lid. For this reason, due to manufacturing variations between the clamp main body and the lid, an amount of contact (wrap amount) between the tubular member and the plate spring when the lid is closed may be larger than a designed value. In this case, when the tubular member is attached to the clamp, a large amount of force is required to lock the lid onto the clamp main body. Therefore, an operator was required to do tedious work of locking the lid using a jig.

An exemplary aspect of the disclosure provides a protector and a wire harness that allow a wire member to be easily attached to a housing portion.

A protector that resolves the above-described problem is configured so as to be fixed to an attachment target, integrally with a wire member. The protector comprises a housing portion that accommodates the wire member. The housing portion has an opening into which the wire member is fit. The housing portion includes (i) a support wall that supports the wire member that is accommodated in the housing portion, and (ii) a retaining section that is formed elastically deformable so as to retain the wire member. The support wall and the retaining sections sandwich the wire member therebetween so as to retain the wire member.

A wire harness that resolves the above-described problem is configured so as to include (i) a wire member and (ii) a protector that is fixed to an attachment target, integrally with the wire member. The protector comprises a housing portion that accommodates the wire member. The housing portion has an opening into which the wire member is fit. The housing portion includes (i) a support wall that supports the wire member that is accommodated in the housing portion, and (ii) a retaining section that is formed elastically deformable so as to retain the wire member. The support wall and the retaining sections sandwich the wire member therebetween so as to retain the wire member.

According to this disclosure, the wire member can be easily attached to the housing portion.

### BRIEF DESCRIPTION OF THE DRAWINGS

FIG. 1 is a partial perspective view of a harness.

FIG. 2 is a perspective view of a protector as seen from an opening.

FIG. 3 is a cross-sectional view of the III-III line shown in FIG. 2.

FIG. 4 is a cross-sectional view of the IV-IV line shown in FIG. 1.

FIG. 5 is a plan view of a protector.

FIG. 6 is a perspective view of a protector as seen from an outside surface of a bottom wall.

FIG. 7(a)-7(d) are schematic cross-sectional view showing a procedure for attaching a wire member to a protector.

FIG. 8 is a cross-sectional view showing an engagement area of a retaining section.

FIG. 9 is a perspective view of a protector in another example.

FIG. 10 is a front view of a protector.

### DETAILED DESCRIPTION OF EMBODIMENTS

First, embodiments of this disclosure will be listed and explained.
[1] A protector of this disclosure is configured so as to be fixed to an attachment target, integrally with a wire member. The protector comprises a housing portion that accommodates the wire member. The housing portion has an opening into which the wire member is fit. The housing portion includes (i) a support wall that supports the wire member that is accommodated in the housing portion, and (ii) a retaining section that is formed elastically deformable so as to retain the wire member. The support wall and the retaining section sandwich the wire member therebetween so as to retain the wire member.

According to this configuration, when the wire member is attached to the housing portion, the wire member can be simply inserted from the opening of the housing portion. Accordingly, when the wire member is attached to the housing portion, tedious work using a jig is not required. Therefore, the wire member can be easily attached to the housing portion.
[2] In [1] above, the support wall is a bottom wall of the housing portion. The retaining section is arranged at a position facing the bottom wall. According to this configuration, the bottom wall of the housing portion and the retaining section(s) sandwich the wire member therebetween so as to retain the wire member.
[3] In [1] or [2] above, the retaining section is one among a plurality of retaining sections that comprise a plurality of pairs of retaining sections. The plurality of pairs of retaining sections are arranged at a plurality of different positions in a longitudinal direction of the housing portion. The respective pairs of the plurality of pairs of retaining sections are arranged so as to sandwich the wire member from both sides in a width direction of the housing portion. According to this configuration, the wire member can be retained at the plurality of different positions in the longitudinal direction of the housing portion. Therefore, it is possible to make it difficult for the wire member to slip out of the housing portion.
[4] In [3] above, two pairs of the plurality of pairs of retaining sections are respectively arranged at both ends of the housing portion in the longitudinal direction. According to this configuration, the two pairs of the retaining sections at both ends of the housing portion firmly retain the wire member at a plurality of longitudinal positions spaced apart in the longitudinal direction of the wire member, which further contributes to making it difficult for the wire member to slip out of the housing portion.
[5] In any of [1]-[3] above, the retaining section(s) includes a taper section at a tip end of the retaining section for guiding the wire member to the inside of the housing portion. According to this configuration, it becomes easier to accommodate the wire member in the housing portion; thus, it further contributes to simplifying workability when attaching the wire member to the housing portion.
[6] In any of [1]-[5] above, the retaining section(s) includes (i) a base end connected to a support wall and (ii) a tip end extending from the base end and formed thicker than the base end. According to this configuration, by making the tip end of the retaining sections to have a wide shape, an engaging area of the retaining section with respect to the wire member can be sufficiently obtained. Thus, this contributes to improving the retaining force when retaining the wire member by the retaining section.
[7] In any of [1]-[6] above, the housing portion includes a hole through which a fluid that has flowed into the housing portion can be discharged to the outside of the housing portion. According to this configuration, this suppresses a fluid such as water from accumulating in the housing portion, which contributes to suppressing deterioration of the wire member.
[8] In any of [1]-[7] above, the wire member includes one or a plurality of wires, and a tubular-shaped outer member that accommodates the wires therein. The support wall and the retaining section(s) sandwich an outer circumferential surface of the outer member. According to this configuration, the wire member in which a wire is accommodated inside the outer member can be easily attached to the retaining section. Furthermore, it is also possible to retain the wire member by hooking the retaining section on the outer circumferential surface of the outer member.
[9] In [8] above, the retaining section includes an arc-shaped inner circumferential surface that matches the outer circumferential surface of the outer member. According to this configuration, it is possible to bring the retaining section into surface contact with the wire member, which contributes to improving the retaining force.
[10] In any of [1]-[9] above, the protector includes a lid that closes the opening. According to this configuration, it becomes difficult for foreign matter to enter the inside of the housing portion; thus, the wire member can be protected from foreign matter, which contributes to suppressing the deterioration of the wire member.
[11] A wire harness of this disclosure includes (i) a wire member and (ii) a protector that is fixed to an attachment target, integrally with the wire member. The protector comprises a housing portion that accommodates the wire member. The housing portion has an opening into which the wire member is fit. The housing portion includes (i) a support wall that supports the wire member that is accommodated in the housing portion, and (ii) a retaining section that is formed elastically deformable so as to retain the wire member. The support wall and the retaining section sandwich the wire member therebetween so as to retain the wire member. According to this configuration, effects similar to those of the protector can be obtained.

### Details of Modes of this Disclosure to be Implemented

Specific examples of a protector and a wire harness of this disclosure will be explained with reference to the drawings below. Additionally, this disclosure is not limited to these examples, is shown by the scope of the claims, and is intended to include meanings of equivalents to the scope of the claims and all changes within the scope. In each drawing, for convenience of explanation, some components of the configuration may be exaggerated or simplified. Furthermore, the dimensional proportions of each component may also differ from the actual ones.

### Summary of Wire Harness 1

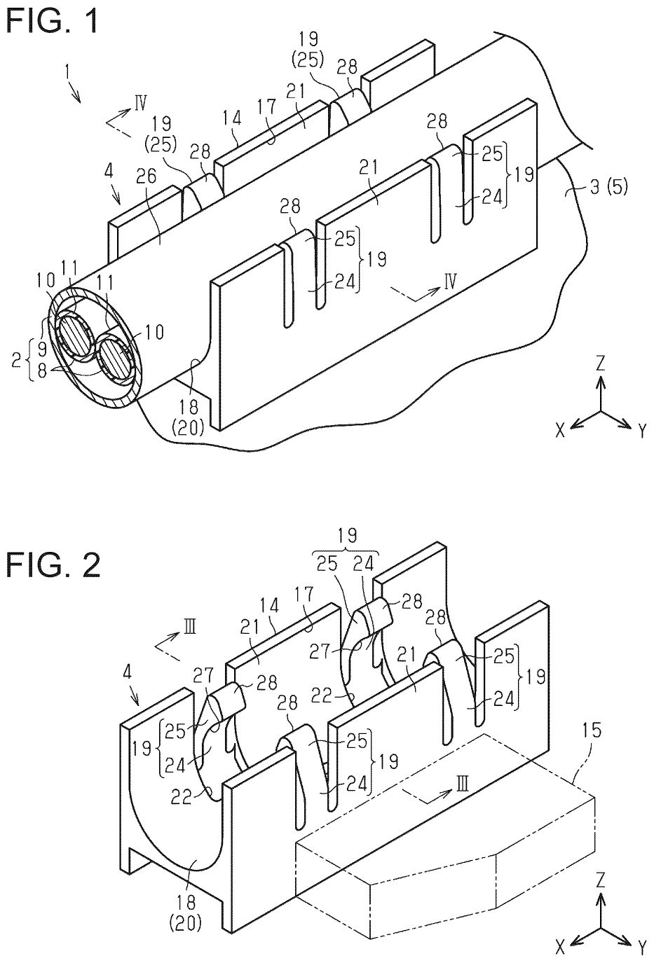

As shown in FIG. 1, a wire harness 1 includes a wire member 2 (wire), and a protector 4 that is fixed to an attachment target 3, integrally with the wire member 2. Thus, the wire member 2 is fixed to an attachment target 3 by the protector 4. The protector 4 is used, for example, for protection of the wire member 2 and path regulation of the wire member 2. The attachment target 3 is, for example, a body 5 of a vehicle. The body 5 is, for example, a panel under a floor.

### Summary of Wire Member 2

As shown in FIG. 1, the wire member 2 includes one or a plurality of wires 8, and a tubular-shaped outer member 9 that accommodates the wires 8 therein. In this example, there are two wires 8. Each of the wires 8 includes, for example, a core wire 10 formed by a conductor, and an insulating coating 11 that covers an outer periphery of the core wire 10. The wires 8 may be, for example, either non-shielded wires without a magnetic shielding structure or shielded wires with a magnetic shielding structure.

The core wire 10 is, for example, a twisted wire formed by twisting a plurality of metal wires together, a columnar conductor formed by a single columnar metal rod with a solid interior, a tubular conductor with a hollow interior therein, or the like. The core wire 10 may be a combination of a plurality of types of conductors, for example, a twisted wire, a columnar conductor, a tubular conductor, and the like. For example, a single core wire, a bus bar, and the like can be listed as a columnar conductor. A metal material, for example, copper, aluminum, or the like is used as a material for the core wire 10.

The insulating coating 11 coats the entire outer circumferential surface of the core wire 10. The insulating coating 11 is formed by an insulating material, for example, a synthetic resin or the like. As the material of the insulating coating 11, for example, a synthetic resin whose main component is a polyolefin resin such as cross-linked polyethylene or cross-linked polypropylene is used. As the material for the insulating coating 11, one type of material may be used alone, or two or more types of materials may be used in an appropriate combination.

The outer member 9 has a cylindrical shape that covers the entire outer circumference of the wire member 2 in the circumferential direction. The protector 4 is arranged so as to cover part of the outer circumference of the wire member 2 in the longitudinal direction. The outer member 9 is, for example, a metal pipe. The outer member 9 is preferably, for example, an aluminum pipe.

### Summary of Protector 4

As shown in FIG. 2, the protector 4 includes a housing portion 14 (housing) that accommodates the wire member 2, and a fixing section 15 that is fixed to the attachment target 3. The housing portion 14 and the fixing section 15 may be, for example, either a structure formed integrally or a structure in which separate members are assembled. The protector 4 (at least the housing portion 14) is made of, for example, resin. The fixing section 15 is fixed to the attachment target 3 (see FIG. 1), for example, with a threaded member (undepicted) such as a bolt.

### Specific Configuration of Housing portion 14 and Retaining Section 19

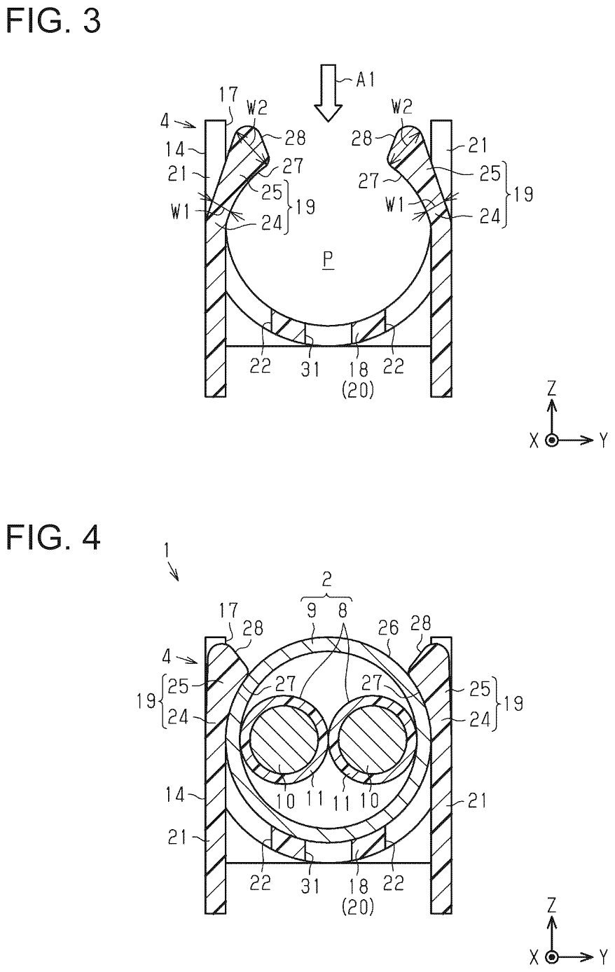

As shown in FIGS. 2 and 3, the housing portion 14 includes an opening 17 for fitting the wire member 2 into the housing portion 14. For example, the opening 17 is open along an entire axial direction (X-axis direction of FIG. 2) of the housing portion 14 at the top (for example, top of paper) of the housing portion 14. The housing portion 14 is formed into a substantially arc shape as seen from the axial direction.

The housing portion 14 includes (i) a support wall 18 that supports the wire member 2 accommodated in the housing portion 14, (ii) at least one retaining section 19 that is formed elastically deformable so as to retain the wire member 2, and a pair of side walls 21 arranged along both sides of the support wall 18. The support wall 18 is, for example, a bottom wall 20 of the housing portion 14. The support wall 18 includes a substantially arc-shaped inner circumferential surface that matches an outer circumferential surface 26 (see FIG. 1 and the like) of the wire member 2. The support wall 18 is formed so as to connect the pair of side walls 21 of the housing portion 14. The at least one retaining section 19 may be one among a plurality of retaining sections. The plurality of retaining sections may form a pair of retaining sections, and two of the retaining sections that form the pair of retaining sections may face each other. In another example, the plurality of retaining sections may form a plurality of pairs of retaining sections. The retaining section(s) 19 may be referred to as an elastic retention component or an elastic retention arm with a claw(s). A pair of retaining sections facing each other may be referred to as a sub set of pinching arms. Each of the retaining sections 19 may be, for example, deformable independently with respect to the substantially arc-shaped inner circumferential surface of the support wall 18.

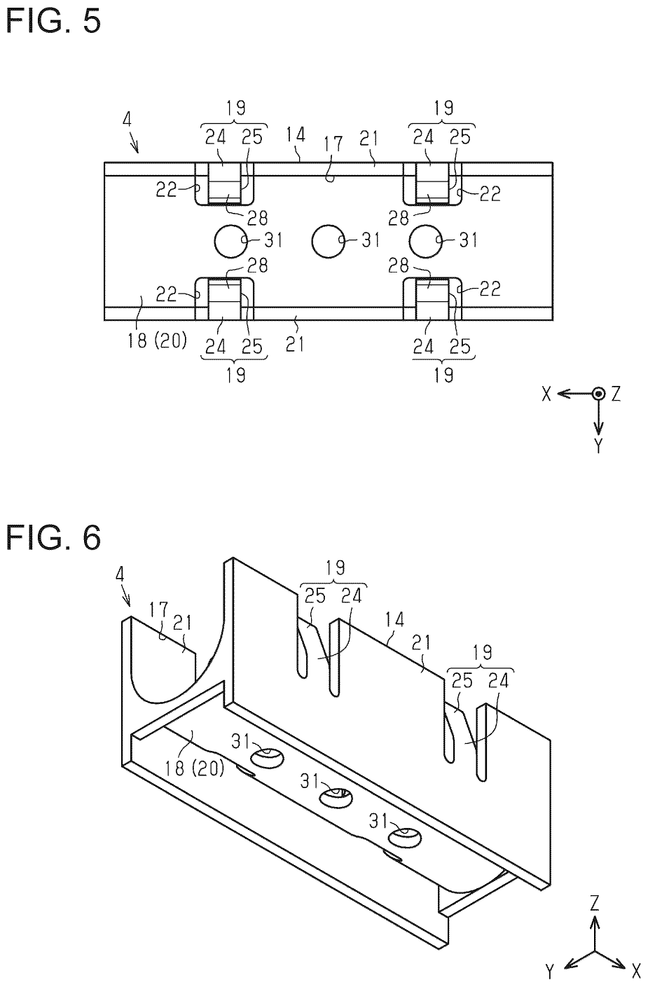

The retaining section(s) 19 includes a spring function for retaining the wire member 2. In this case, the retaining section(s) 19 functions as, for example, a resin spring. The retaining section(s) is arranged at a position facing the bottom wall 20. The position facing the bottom wall 20 here is a position of the retaining section(s) 19 that is set such that an internal space P of the retaining section(s) 14 exists between the retaining section 19 and the bottom wall 20. The retaining section(s) 19 is arranged, for example, in line with the side wall 21 of the housing portion 14 in the longitudinal direction (Y-axis direction of FIG. 5) of the housing portion 14. The retaining section(s) 19 is formed in such a shape that it leans into the interior of the housing portion 14. At the base end of each retaining section 19, a hole 22 is formed that is generated when the retaining section 19 (housing portion 14) is manufactured by die molding.

As shown in FIG. 3, the retaining section(s) 19 includes a base end 24 connected to the support wall 18 (bottom wall 20) and a tip end 25 extending from the base end 24. The tip end 25 is formed to be thicker than the base end 24. For example, a relationship of W2>W1 is set between thickness W1 of the base end 24 and thickness W2 of the tip end 25. The retaining section(s) 19 includes an arc-shaped inner circumferential surface 27 that matches the outer circumferential surface 26 of the wire member 2 (see FIG. 1 and the like).

The retaining section(s) 19 includes a taper section 28 for guiding the wire member 2 to the inside of the housing portion 14 at the tip end of the retaining section 19. In this example, the taper section 28 is formed as an inclined surface such that a distance between the pair of retaining sections 19 becomes smaller toward a fitting direction of the wire member 2 (arrow A1 direction of FIG. 3).

As shown in FIG. 4, the support wall 18 and the retaining section(s) 19 sandwich the wire member 2 therebetween such that the housing portion 14 retains the wire member 2. For example, the support wall 18 and the retaining sections 19 sandwich the outer circumferential surface 26 of the outer member 9.

As shown in FIG. 5, a pair of retaining sections 19 is provided so as to sandwich the wire member 2 from both sides in a width direction of the housing portion 14 (Y-axis direction of FIG. 5). For example, the retaining sections 19 of the pair are set so as to face each other in the width direction of the housing portions 14 (Y-axis direction of FIG. 5). A plurality of pairs of retaining sections 19 may be respectively set at a plurality of different positions in the longitudinal direction of the housing portion 14 (X-axis direction of FIG. 5). For example, the plurality of pairs of retaining sections 19 may be two pairs of retaining sections that are respectively arranged at both ends of the housing portion 14 in the longitudinal direction.

### Holes 31 for Discharging in Housing Portion 14

As shown in FIGS. 5 and 6, the housing portion 14 includes holes 31 through which a fluid that has flowed into the housing portion 14 can be discharged to the outside of the housing portion 14. The holes 31 are arranged, for example, at the lowermost point of the support wall 18 (bottom wall 20). In this example, there are a plurality of holes 31. The plurality of holes 31 are arranged in a line at equal intervals along the longitudinal direction of the housing portion 14.

### Operation of Mode to be Implemented

Next, an operation of the protector 4 (wire harness 1) of this mode will be explained.

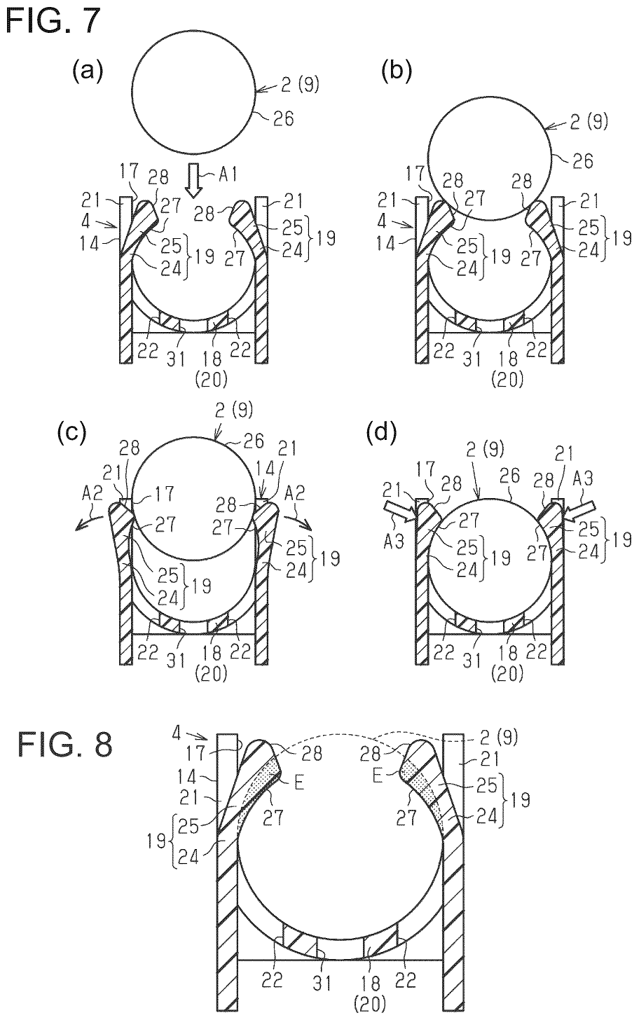

As shown in FIG. 7 (a) and (b), when the wire member 2 is attached to the protector 4, the wire member 2 is positioned at the opening 17 of the housing portion 14 of the protector 4 and then the wire member 2 is fit into the housing portion 14 (arrow A1 direction in FIG. 7(a)) from the opening 17 of the wire member 2. At this time, fitting of the wire member 2 is guided by the taper sections 28 of the retaining sections 19. That is, by arranging the taper sections 28 at the tip ends 25 of the retaining sections 19, the wire member 2 can be easily fit into the housing portion 14.

As shown in FIG. 7(c), as the wire member 2 is forcibly pushed further into the housing portion 14, the retaining sections 19 open against their own spring force, whereby the wire member 2 is allowed to fit in. As the wire member 2 is fitted into the housing portion 14, the retaining sections 19 slide on the outer circumferential surface 26 of the outer member 9.

As shown in FIG. 7(d), when the wire member 2 is fitted all the way into the housing portion 14, the retaining sections 19 press the wire member 2 down from above. That is, a pair of the retaining sections 19 press the wire member 2 in an urging direction (arrow A3 directions of FIG. 7(d)) by a spring function. Thus, the support wall 18 and the retaining sections 19 sandwich the wire member 2 therebetween such that the wire member 2 can be retained within the housing portion 14.

As shown in FIG. 8, a retaining force of each of the retaining sections 19 that presses the wire member 2 is determined by an overlapping area E between (i) each of the retaining sections 19 when the wire member 2 is not accommodated in the housing portion 14 and (ii) the wire member 2 accommodated in the housing portion 14. In this case, the overlapping area E is set by making the tip end 25 of each of the retaining sections 19 thicker than the base end 24. Thus, a sufficient retaining force of the spring function of each of the retaining sections 19 is set.

### Effects of Mode

According to the protector 4 (wire harness 1) of the above mode, the following effects can be obtained.
(1) The protector 4 fixed to an attachment target 3, integrally with a wire member 2, includes the housing portion 14 that accommodates the wire member 2. The housing portion 14 includes the opening 17 into which the wire member 2 is fit. The housing portion 14 includes (i) the support wall 18 that supports the wire member 2 accommodated in the housing portion 14, and (ii) the retaining sections 19 that are formed elastically deformable so as to retain the wire member 2. The support wall 18 and the retaining sections 19 sandwich the wire member 2 therebetween so as to retain the wire member 2.

According to this configuration, when the wire member 2 is attached to the housing portion 14, the wire member 2 can be simply inserted from the opening 17 of the housing portion 14. Accordingly, when the wire member 2 is attached to the housing portion 14, tedious work using a jig is not required. Therefore, the wire member 2 can be easily attached to the housing portion 14.
(2) The support wall 18 is the bottom wall 20 of the housing portion 14. Each of the retaining sections 19 is arranged at a position facing the bottom wall 20. According to this configuration, the bottom wall 20 and the retaining sections 19 securely sandwich the wire member 2 therebetween such that the housing portion 14 can retain the wire member 2.
(3) Each retaining section 19 is one among a plurality of retaining sections that comprise a plurality of pairs of retaining sections 19. The plurality of pairs of retaining sections 19 are arranged at a plurality of different positions in a longitudinal direction of the housing portion 14. The respective pairs of the plurality of pairs of retaining sections 19 are arranged so as to sandwich the wire member 2 from both sides in a width direction of the housing portion 14. According to this configuration, the wire member 2 can be retained at the plurality of different positions in the longitudinal direction of the housing portion 14. Therefore, it is possible to make it difficult for the wire member 2 to slip out of the housing portion 14.
(4) Two pairs of the plurality of pairs of retaining sections 19 are respectively arranged at both ends of the housing portion 14 in the longitudinal direction. According to this configuration, the two pairs of the retaining sections 19 at both ends of the housing portion 14 firmly retain the wire member 2 at a plurality of longitudinal positions spaced apart in the longitudinal direction of the wire member 2, which further contributes to making it difficult for the wire member 2 to slip out of the housing portion 14.
(5) The retaining sections 19 include the taper sections 28 at tip ends of the retaining sections 19 for guiding the wire member 2 to the inside of the housing portion 14. According to this configuration, it becomes easier to accommodate the wire member 2 in the housing portion 14; thus, it further contributes to simplifying workability when attaching the wire member 2 to the housing portion 14.
(6) The retaining sections 19 include (i) the base ends 24 connected to the support wall 18 and (ii) the tip ends 25 extending from the base ends 24 and formed thicker than the base ends 24. According to this configuration, by making the tip ends 25 of the retaining sections 19 to have a wide shape, an engaging area of the retaining sections 19 with respect to the wire member 2 can be sufficiently obtained. Thus, this contributes to improving the retaining force when retaining the wire member 2 by the retaining sections 19.
(7) The housing portion 14 includes holes 31 through which a fluid that has flowed into the housing portion 14 can be discharged to the outside of the housing portion 14. According to this configuration, this suppresses a fluid such as water from accumulating in the housing portion 14, which contributes to suppressing deterioration of the wire member 2.
(8) The wire member 2 includes one or a plurality of wires 8, and a tubular-shaped outer member 9 that accommodates the wires 8 therein. The support wall 18 and the retaining sections 19 sandwich an outer circumferential surface 26 of the outer member 9. According to this configuration, the wire member 2 in which the wires 8 are accommodated inside the outer member 9 can be easily attached to the retaining sections 14. Furthermore, it is also possible to retain the wire member 2 by hooking the retaining sections 19 on the outer circumferential surface 26 of the outer member 9.
(9) The retaining sections 19 include arc-shaped inner circumferential surfaces 27 that match the outer circumferential surface 26 of the outer member 9. According to this configuration, it is possible to bring the retaining sections 19 into surface contact with the wire member 2, which contributes to improving the retaining force.
(10) The retaining sections 19 are integrally formed with the housing portion 14. For this reason, unlike a clamp with a two-part structure including a clamp main body and a lid, a difficulty in attaching the wire member 2 due to manufacturing variations between parts does not arise. That is, while the protector 4 is one part, it can retain the wire member 2 with the same retaining force as a clamp with a two-part structure and be fixed to the attachment target 3.

### Other Modes

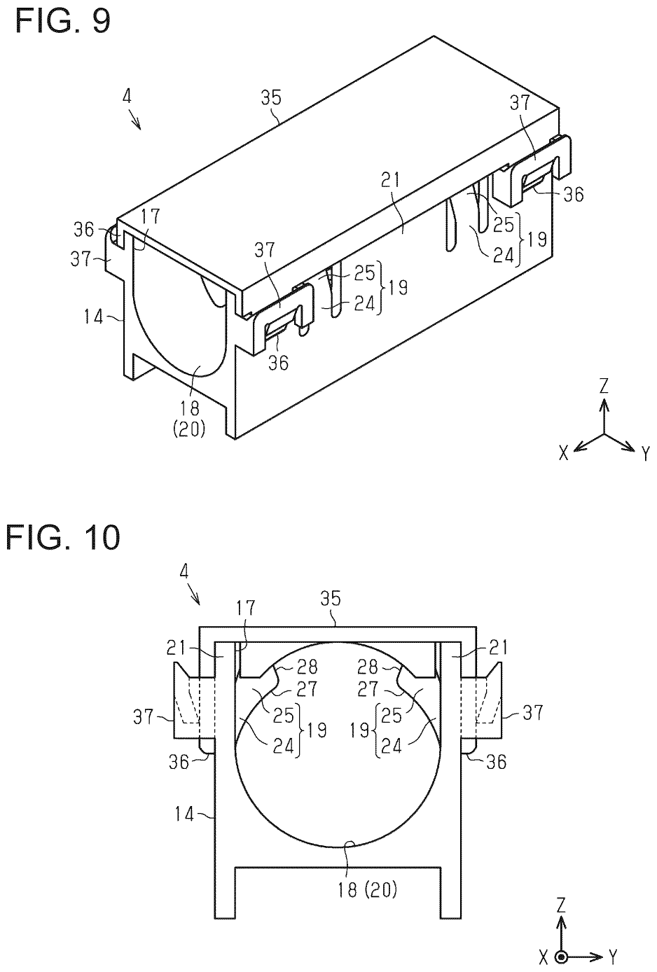

This mode can be implemented with the following changes. This mode and the following modifications can be implemented in combination as long as there are no technical contradictions.
As shown in FIG. 9, the protector 4 may include a lid 35 that closes the opening 17 of the housing portion 14. The lid 35 is attached to the housing portion 14 by, for example, engaging engagement sections 36 formed in the lid 35 with engaged sections 37 of the housing portion 14. Various configurations, for example, a press-fit structure or snap-fit structure, can be applied to the configuration of the engagement sections 36 and the engaged sections 37. When the lid 35 is provided in the protector 4, it becomes difficult for foreign matter to enter the inside of the housing portion 14; thus, the wire member 2 can be protected from foreign matter, which contributes to suppressing the deterioration of the wire member 2.

As shown in FIG. 10, for example, preferably, the lid 35 does not retain the wire member 2. For example, the lid 35 may merely contact a periphery of the wire member 2 and may not have to have a positive effect on the retaining force with respect to the wire member 2. Thus, even if the protector 4 is configured to include the lid 35, the lid 35 does not end up becoming difficult to attach to the housing portion 14.
Two pairs of the retaining sections 19 are not limited to be arranged at both ends of the housing portion 14 in the longitudinal direction. For example, they may be arranged closer to the center of the housing portion 14 in the longitudinal direction.
Claws that catch on the wire member 2 may be provided at the tip ends of the retaining sections 19.
The retaining sections 19 are not limited to a shape in which the width of the tip end is larger than the base end, and may have the same width at the base end and the tip end.
There may be three or more sets of the retaining sections 19.
There may be only one retaining section 19 in the housing portion 14.
The retaining section(s) 19 may be arranged only at one side of the housing portion 14 in the width direction.
The retaining section(s) 19 may be formed, for example, as a plate spring.
The retaining section(s) 19 is not limited to being integrally formed with the housing portion 14, and may be formed by a member different from the retaining section(s) 19 and the housing portion 14.
The support wall 18 of the housing portion 14 is not limited to being the bottom wall 20 of the housing portion 14, and may be the side wall 21 of the housing portion 14 or may be a part including the side wall 21.
According to the position of the support wall 18 facing the retaining section(s) 19, the position of the retaining section(s) 19 may be changed to another position.
The protector 4 is not limited to being attached with the opening 17 facing upward. For example, it may be attached with the opening 17 facing horizontally.
There may be a plurality of fixing sections 15.
The fixing section(s) 15 may be fixed to the attachment target 3 by, for example, a plurality of fastening parts (screws, bolts, or the like).
The outer member 9 is not limited to a metal pipe. The outer member 9 may be, for example, a corrugated tube.
The wire member 2 may not include the outer member 9. For example, the wire member 2 may be one or a plurality of wires 8. In this case, the outer circumferential surface of one or a plurality of wires 8 may directly contact the protector 4 (for example, the support wall 18).
The attachment target 3 is not limited to the body 5 of the vehicle and may be another location, for example, an engine compartment of the vehicle.
The protector 4 (wire harness 1) is not limited to one for in-vehicle use and may be applied to another component or device.
In the non-limiting example shown in FIG. 1, the protector 4 may be configured so as to accept a certain length portion of the wire member 2. For example, the configuration may be such that a wiring route of that length portion can be defined. The housing portion 14 of the protector 4 may be referred to as a trough having a trough length.
In the non-limiting examples shown in FIGS. 1-4 and 6, the protector 4 may include a leg(s) protruding from the housing portion 14. The leg of the protector 4 may be a plate-like protrusion extending in the longitudinal direction of the housing portion 14. Such a leg is advantageous for improving mechanical stiffness of the housing portion 14.
This disclosure was written with reference to modes, but it is understood that this disclosure is not limited to the modes or configuration. This disclosure also includes various modifications and modifications within equivalent ranges. Additionally, various combinations and configurations, and furthermore, combinations and configurations that include only one element, more than one, or less than one element, fall within the scope and idea of this disclosure.

1. A protector that is configured to be fixed to an attachment target, integrally with a wire, the protector comprising:
a housing that is configured to accommodate the wire and includes an opening into which the wire is fit, wherein:
the housing includes: (i) a support wall that is configured to support the wire that is accommodated in the housing, and (ii) a retaining section that is elastically deformable so as to retain the wire;
the protector further includes a leg that is a plate protrusion protruding from the housing and extending in a longitudinal direction of the housing; and
the support wall and the retaining section are configured to sandwich the wire therebetween so as to retain the wire.

2. The protector according to claim 1, wherein:
the support wall is a bottom wall of the housing; and
the retaining section is arranged at a position facing the bottom wall.

3. The protector according to claim 1, wherein:
the housing includes a plurality of retaining sections that includes the retaining section, the plurality of retaining sections being divided into a plurality of pairs of retaining sections; and
the plurality of pairs of retaining sections are arranged at a plurality of different positions in a longitudinal direction of the housing, and respective pairs of the plurality of pairs of retaining sections are arranged so as to sandwich the wire from both sides in a width direction of the housing.

4. The protector according to claim 3, wherein:
two pairs of the plurality of pairs of retaining sections are respectively arranged at both ends of the housing in the longitudinal direction.

5. The protector according to claim 1, wherein:
the retaining section includes a taper section at a tip end of the retaining section for guiding the wire to an inside of the housing.

6. The protector according to claim 1, wherein the retaining section includes:
a base end connected to the support wall; and
a tip end extending from the base end and formed thicker than the base end.

7. The protector according to claim 1, wherein:
the housing includes a hole through which a fluid that has flowed into the housing can be discharged outside the housing.

8. The protector according to claim 1, wherein:
a tubular-shaped outer member is configured to accommodate a plurality of wires that includes the wire therein; and
the support wall and the retaining section sandwich an outer circumferential surface of the outer member.

9. The protector according to claim 8, wherein:
the retaining section includes an arc-shaped inner circumferential surface that matches the outer circumferential surface of the outer member.

10. The protector according to claim 1, further comprising:
a lid that closes the opening.

11. A wire harness comprising
a wire; and
protector that is configured to be fixed to an attachment target, integrally with the wire, wherein:
the protector comprises a housing that accommodates the wire and includes an opening into which the wire is fit;
the housing includes: (i) a support wall that supports the wire that is accommodated in the housing, and (ii) a retaining section that is elastically deformable so as to retain the wire;
the protector further includes a leg that is a plate protrusion protruding from the housing and extending in a longitudinal direction of the housing; and
the support wall and the retaining section sandwich the wire therebetween so as to retain the wire.
